(19) United States
(12) Patent Application Publication
(10) Pub. No.: US 2011/0000970 A1
(43) Pub. Date: Jan. 6, 2011

(54) ENCAPSULATED RFID LABEL, AND RELATED METHODS

(75) Inventor: Akash ABRAHAM, Strongsville, OH (US)

Correspondence Address: Avery Dennison Corporation;Amanda Wittine, 8080 Norton Parkway, 22-D, Mentor, OH, 44060, US

(73) Assignee: AVERY DENNISON CORPORATION, Pasadena, CA (US)

(21) Appl. No.: 12/703,452

(22) Filed: Feb. 10, 2010

Related U.S. Application Data
(63) Continuation-in-part of application No. 11/833,950, filed on Aug. 3, 2007.

(51) Int. Cl. G06K 19/07; G06K 19/18

(52) U.S. Cl. 235/492; 427/7

(57) ABSTRACT

This invention relates to an encapsulated radio frequency identification device, having a chip, an antenna, and a substrate comprising a first surface and a second surface, said chip and said antenna included on said first surface, primer, and a polymer wherein the encapsulated RFID illustrates flame retardant and resistant properties and wherein the encapsulated RFID is flexible and able to conform to curved surfaces. A method of manufacturing an encapsulated RFID device is also provided.

### CROSS-REFERENCE TO RELATED APPLICATION

The present application is a continuation-in-part of U.S. patent application Ser. No. 11/833,950 filed on Aug. 3, 2007, entitled “Moldable Radio Frequency Identification Device,” by Akash Abraham and Ted Hoerig, which is incorporated by reference herein in its entirety.

### FIELD OF THE INVENTION

This invention relates to molded products with in-mold radio frequency identification (“RFID”) labels and more particularly, to RFID labels having fire resistant or fire retardant properties.

### BACKGROUND OF THE INVENTION

A RFID label is a smart label that could be used for various purposes such as the identification and tracking of goods. Molded products, such as containers in a warehouse and plastic bins in a manufacturing facility, may require an RFID label because the containers have to be identified in the warehouse and the plastic bins have to be tracked during the manufacturing operation. This can be accomplished by either attaching the label to the surface of the product via an adhesive or fastener solution or by embedding the label into the molded product. Attaching a RFID label to a product by using an adhesive or a fastener has the risk of the label separating or delaminating from the product or simply being knocked off the product. The labels in this scenario are not flush with the surface and therefore are subject to various environmental hazards that can cause separation.

In addition, RFID devices that have been attached to containers or pallets have often been hard encapsulated tags, that is a RFID device with a rigid or inflexible shell surrounding the RFID device. These structures suffer from being generally incapable of conforming to an outer surface of a container or the like to which it has been attached. Such rigid casings can further be damaged due to impacts, such as might occur with a fork truck picking up a pallet or a container being bumped against other containers or walls during the loading or handling of the containers.

A RFID inlay or label generally includes a chip or a “strap” connected to antenna disposed on a substrate made of polymers such as polyethylene terepthalate (“PET”). RFID labels having a substrate made of material such as PET may be difficult to embed in a plastic product because the PET resin does not bond well with high density polyethylene (“HDPE”), a resin that is commonly used in the manufacture of molded plastic products such as bins, pallets, and containers. If the RFID label does not bond well with the bulk material, such as the HDPE used to make a plastic product, the label may not remain a part of the molded product. The present invention satisfies this need.

RFID inlays or labels that provide resistance to harsh chemicals and fluids found in industrial applications are desired in the marketplace. Traditionally, durable tags were “hard encapsulated” meaning that the tags were encased in an injection molding or hard lamination process exhibiting a rigid structure. These traditional rigid tags offered resistance against the environment, but were unable to conform to curved surfaces. This inability to conform made it difficult to track various items if their geometry did not suit a rigid tag. The present invention is an improvement over the traditional “hard encapsulated” RFID device and offers a durable RFID product that is encapsulated allowing protection of the RFID device against the environment, ESD, and impact hazards while maintaining a level of moldability and flexibility.

The present invention is desired in the marketplace to enable the RFID tagging of products with curved geometries with significant exposure to hazards. Examples of products that can benefit from the present invention include but are not limited to returnable containers, aerospace and automotive parts, and medical parts. By making the RFID label an integral part of the molded product and flush with the surface, the chances of the label separating from the product are minimized. Molded labels are useful in creating a discrete, permanent identification method for the plastic molded products.

Additionally, the present invention provides for an encapsulated RFID device that has a certain level of flame retardation and resistance while maintaining durability, readability, and flexibility. This is beneficial in industries such as industries relating to chemicals where marking of products via RFID is desired but the RFID will be exposed to a harsh exterior environment. If an RFID is exposed to a flame without any type of fire resistance/retardation component the tag will ultimately be destroyed quickly obliterating the information stored on the tag. There is currently an unfilled need in the marketplace for an RFID that is capable of withstanding exposure to high levels of heat so as to preserve the integrity of the RFID.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

This invention relates to an RFID device that is encapsulated by a polymeric material having flame resistant and retardant properties wherein the encapsulated RFID is flexible and conformable to curved surfaces. A method of construction is also provided. In one embodiment of the invention, the label includes an RFID inlay and a substrate made of a polymer material such as PET underneath the RFID inlay. The substrate including the RFID inlay is chemically primed, and then covered with a polymer having flame retardant and resistance properties. An advantage of the present invention is that a layer of adhesive does not need to be present in the invention.

The layer of primer can be made of a water-based material. Additionally, the layer of primer can be non-adhesive and may have flame retardant and resistant properties.

In another embodiment, the layer of polymer can be made of low density polyethylene (“LDPE”), polypropylene (“PP”), and/or ethyl vinyl acetate (“EVA”) having flame retardant and resistant additives. Preferably, the polymer is a halogen material having flame retardants. Possible flame retardants include chlorine-containing compounds, bromine containing compounds, and halogen containing phosphoric esters. It is also worth noting that the polymer may be halogen free and may be copolymerized or mixed with a plastic material. Phosphoric or halogen compound-containing flame retardants are copolymerized with linear polyesters composed of acidic components. Additionally, polyethelyne terphthalate containing phosphorous-containing flame retardants may also be used for the present invention.

An exemplary method according to the invention is a method of manufacturing an encapsulated RFID label having flame retardant and resistant properties that maintains a level of flexibility and is able to conform to curved surfaces. The method includes providing a primer, a polymer having flame retardant properties, and an RFID device, the RFID device including a chip, an antenna, and a substrate, where the substrate includes a first surface and a second surface, the chip and the antenna are included on the first surface; disposing a first layer of the primer on the first surface of the RFID device; disposing a second layer of primer on the second surface of the RFID; disposing a first layer of the polymer on the first layer of primer and disposing a second layer of the polymer on the second layer of primer, encapsulating the entire RFID device.

In other, more detailed features of the invention, the polymer can be disposed on the first and second layer of primer by slot die coating and extrusion coating.

Other features and advantages of the present invention will become apparent to those skilled in the art from the following detailed description. It is to be understood, however, that the detailed description of the various embodiments and specific examples, while indicating preferred and other embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 is a cross-sectional view of an example embodiment of an RFID label;

FIG. 2 is a cross-sectional view of yet another example embodiment of the RFID label;

FIG. 3 is a cross-sectional view of an example embodiment of the RFID label of FIG. 1 included in a molded product; and

FIG. 4 illustrates method steps for a method of manufacturing an encapsulated RFID device.

### DETAILED DESCRIPTION OF PREFERRED EMBODIMENTS

The apparatuses and methods disclosed in this document are described in detail by way of examples and with reference to the figures. Unless otherwise specified, like numbers in the figures indicate references to the same, similar, or corresponding elements throughout the figures. It will be appreciated that modifications to disclosed and described examples, arrangements, configurations, components, elements, apparatuses, methods, materials, etc. can be made and may be desired for a specific application. In this disclosure, any identification of specific shapes, materials, techniques, arrangements, etc. are either related to a specific example presented or are merely a general description of such a shape, material, technique, arrangement, etc. Identifications of specific details or examples are not intended to be, and should not be, construed as mandatory or limiting unless specifically designated as such. Selected examples of apparatuses and methods are hereinafter disclosed and described in detail with reference made to FIGURES.

The term “label” as used herein refers to a label, tag, or ticket. The term “Radio Frequency Identification” or “RFID” as used here refers to device that receives or transmits data by radio frequency. The RFID device is of any conventional construction and inlays suitable for use in the present invention are produced as described in U.S. Pat. No. 6,951,596 to Green et al., which is incorporated by reference herein in its entirety. The term “RFID label” refers to a label that includes an RFID device. The present invention, in one embodiment, relates to the discovery that an RFID label when encapsulated with a polymer having flame resistant and retardant properties makes the RFID capable of withstanding extreme heat and flame without disintegrating. Furthermore, the RFID retains its flame retardant and resistant properties while maintaining a level of flexibility.

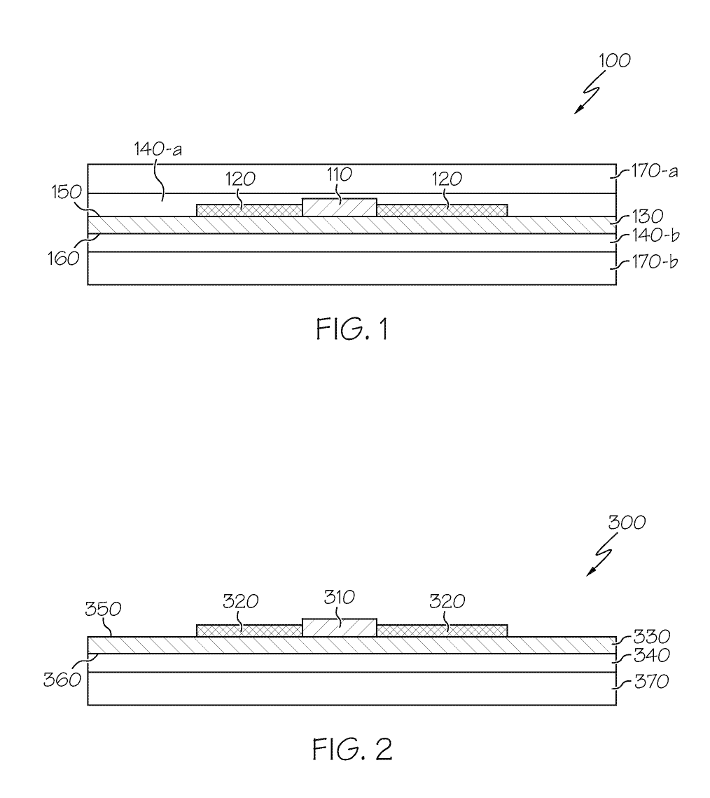

FIG. 1 shows a first embodiment of an RFID label according to the invention. The RFID label, indicated generally at 100, includes an RFID device having an integrated circuit chip 110 connected to an antenna 120. The RFID device is mounted on a substrate 130. A first layer of primer 140(a) is applied to the first surface 150 of the substrate, which is the surface that has the RFID device mounted thereon, and a second layer of primer 140(b) is applied to the second surface 160 of the substrate opposite the first surface 150. When applying primer to the first surface 150 of the substrate, primer is also applied to the RFID chip 110 and the antenna. In one embodiment, the primer is of uniform thickness. In another embodiment, the primer is not of uniform thickness. In a further embodiment, the primer is a water-based primer, which is not an adhesive. In another embodiment, the primer acts as an adhesion promoter that enhances the surface's acceptance of the polymer having fire resistant and retardant properties. In yet another embodiment, the primer serves as an important component of the ultimate adhesion of a polymer to the RFID substrate when malting a polymer-covered RFID label.

After the application of the primer 140, the RFID label 100 is covered with a polymer 170 using well known techniques such as extrusion and coating techniques. The RFID then has flame resistant and retardant properties caused by the addition of flame resistant/retardant additives to the polymer. In a preferred embodiment, the layer of polymer is made out of low density polyethylene (“LDPE”), polypropylene (“PP”), and/or ethyl vinyl acetate (“EVA”) containing flame retardant additives. In one embodiment, the polymer 170 is LDPE. In another embodiment, the polymer is polypropylene (“PP”). In a further embodiment, the polymer is ethyl vinyl acetate (“EVA”). The polymer also can be a mixture of polymeric resins such as LDPE and PP. In another embodiment, the polymer is a halogen comprising flame resistant and/or retardant additives. Slot Die coating is a basic method of applying molten polymeric resin to a substrate. A coating liquid is forced out from a reservoir through a slot by pressure, and transferred to a web. Slot Die coating is a coating with a die against a web. Practical considerations for use of slot die as a coating method are geared to quality needs, e.g., performance, uniformity of coating thickness, freedom from defects, and a uniform surface finish with the desired characteristics.

FIG. 2 shows another embodiment of the present invention wherein only the second surface 360 of the substrate is covered with the primer and polymer. The label, indicated generally at 300, included an RFID device having an integrated circuit chip 310 connected to an antenna 320. The RFID device is mounted on a substrate 330. A primer 340 is applied to a second surface 360 of the substrate which is the surface opposite the first surface that has the RFID device mounted on it. After the application of the primer to the second surface 360 of the substrate, a layer of polymer 370 is added to the second surface of the RFID label using well known techniques such as extrusion and coating.

In a preferred embodiment, adhesives are not utilized. However, it is worth noting that an adhesive layer may be utilized between the primer layers and the polymeric layers or utilized to adhere the RFID to an object. Suitable commercially available adhesives are sold by such commercial sources as Beacon Chemical Company, Inc. of Mount Vernon, N.Y., Acheson Colloids Company of Port Huron, Mich., Quretech of Seabrook, N.H., and Northwest Coatings, Inc. of Oak Creek, Wis. Examples of such adhesives are MAGNACRYL 2793 (“Beacon”), ML 25 184 (“Acheson”), JRX-1068 (“Quretech”) and U.V.-curable-10152 (“Northwest”). Other examples of adhesives available from Beacon Chemical Company, Inc. include MAGNACRYL UV 2601 Epoxy, MAGNACRYL 2296, and MAGNACRYL 2807. Another example of a useful commercially available adhesive material is RAD-CURE UV 1008 (a product of Rad-Cure Corporation of Fairfield, N.J., identified as a U.V. curable, solvent-free adhesive containing 70-95% w multifunctional acrylate monomers, 5-20% w photoinitiator and 0-5% w surfactants.).

Once encapsulated, the RFID device may be variable levels of flame retardance and resistance. For example the encapsulated RFID may be 20% flame retardant or 30% flame retardant. This invention contemplates that other percentages are viable. A RFID with 20% flame retardance with an increased thickness stopped burning after it was removed from flame. A RFID with a 30% flame retardance stopped burning after it was removed from a flame regardless of its thickness. Thus increasing the flame retardance and/or resistance of the polymeric layer in the present invention increases the invention's resistance to flame.

Initial testing simulating a vertical burn using five RFID specimens that were 20% flame retardant was performed in order to test fire retardancy and resistancy, Each specimen having an upper and lower end was supported with a holding clamp and the longitudinal axis of each specimen was held vertically so that the lower end of the specimen was approximately 9.5 mm above a burner tube, and the lower end of the specimen was approximately 305 mm above a dry absorbent surgical cotton lay preferably on the base of the burner tube. The cotton layer was approximately 12.7 mm and 25.4 mm, constructed out of square pieces of surgical cotton having a thickness of 5 mm. The following procedural steps were followed for the vertical burn test. First, the burner tube was ignited and a flame was placed centrally under the lower end of the test RFID tag for ten seconds. Secondly, the burner was removed from underneath the RFID tag. If the RFID tag had not ignited the test was completed. However, if the RFID tag had ignited further observations were recorded regarding the test specimen such as the duration of burn after flame was removed, whether or not the specimen burned up to the holding clamp, and whether or not specimen drips flaming particles ignited the cotton layer. When the flaming of the specimen ceased and if the specimen had not burned up to the holding clamp, a flame was to be placed under the specimen for ten additional seconds and the following observations were to be made and recorded: duration of flame after flame application, whether or not specimen burnt up to the holding clamp, and whether or not specimen dripped flaming particles that ignited the cotton layer.

From this initial test, it was determined that the RFID tags having 20% flame retardancy when placed vertically above a burner did not ignite after approximately ten seconds.

Additionally, the dimensions of encapsulated RFID specimens having a specific percentage of fire retardancy were considered during further vertical burn flammability testing. All of the RFID specimens tested had a thickness of 10 mil. RFIDs having dimensions of 2 in×2 in and 1 in×4.5 in with a 30% flame retardancy extinguished after the flame was removed during testing. An RFID having a dimension of 1 in×4.5 in and 20% flame retardancy also extinguished after the flame was removed during vertical burn testing. However, an RFID having a dimension of 1 in×4.5 in and no fire retardancy continued to burn after the flame was removed, illustrating that a percentage of fire retardancy is desired.

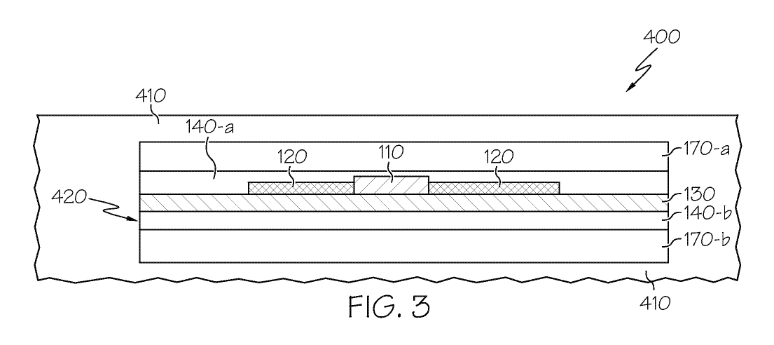

FIG. 3 shows a cross-sectional view of the embodiment of an RFID of FIG. 1 enclosed in a fire resistant/retardant molded product, indicated generally at 400. The method of including the RFID in the molded product comprises placing the RFID label inside the mold proximate to the surface of the mold. The molded product is manufactured by commonly known techniques such as injection or blow molding. In injection molding, the material of construction 410 of the product is injected into the mold to form the molded product 400. In one embodiment, the material of construction is a polymer. In another embodiment, the material of construction is HPDE.

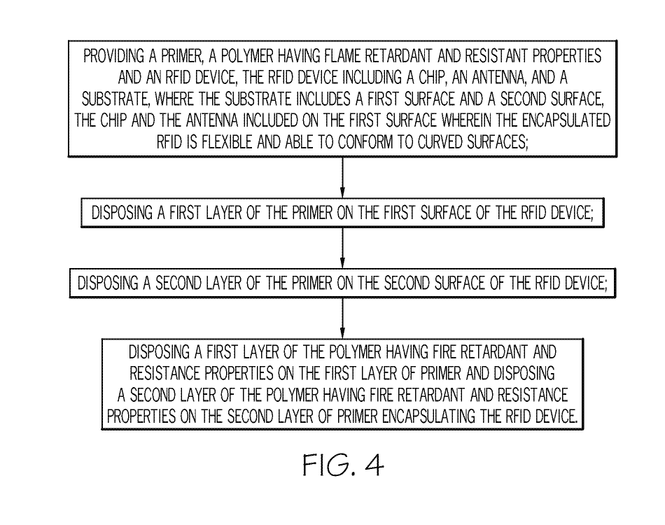

FIG. 4 illustrates a method of manufacturing an encapsulated RFID device 100. First a primer 140, a polymer 170 having flame retardant and resistant properties, and an RFID device, indicated generally at 100, the RFID device 100 including a chip 110, an antenna 120, and a substrate 130, where the substrate includes a first surface 150 and a second surface 160, the chip 110 and the antenna 120 included on the first surface 150 wherein the encapsulated RFID device 100 is flexible and able to conform to curved surfaces 500. Secondly, a first layer of primer 140-a is disposed on the first surface 150 of the RFID device 510. Third, a second layer 140-b of primer on the second surface 160 of the RFID device (520). Lastly, a first layer of the polymer 170-a having fire retardant and resistance properties is disposed on the first layer 140-a of primer, and a second layer 170-b of the polymer having fire retardant and resistance properties is disposed on the second layer 140-b of primer encapsulating the RFID device (530).

In another embodiment of this invention, the chip 110 and antenna 120 are included on the second surface 160 of the substrate 130. A layer of primer 140 and polymer 170 having fire resistant and retardance properties are added only to the second surface 160 of the substrate 130 covering the chip 110 and antenna 120. In another embodiment wherein the chip 110 and antenna 120 are included on the second surface 160 of the substrate 130, a first layer of primer 140-a is disposed on the second surface 160 of the substrate 130 covering the chip 110 and antenna 120 of the RFID. A second layer of primer 140-b is disposed on the first surface 150 of the substrate 130. A first player of polymer 170-a having flame resistance and retardancy properties is disposed over the first layer of primer 140-a and a second layer of polymer 170-b having flame resistance and retardancy properties is disposed over the second layer 140-b of primer.

It will thus be seen according to the present invention a highly advantageous flame retardant RFID tag has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

What is claimed is:

1. An encapsulated radio frequency identification device (RFID), comprising:
a chip, an antenna, and a substrate,
the substrate having a first surface and a second surface, the chip and the antenna included on the first surface,
a first layer of primer disposed on the first surface including over the chip and the antenna and a second layer of primer disposed on the second surface,
a first layer of polymer is disposed on the first layer of primer and a second layer of polymer is disposed on the second layer of primer, the polymer has flame retardant and resistant properties, and
wherein the encapsulated RFID is flexible and able to conform to curved surfaces.

2. The RFID of claim 1, wherein the polymer is extrusion coated on top of the RFID.

3. The RFID of claim 1, wherein the primer is made of a water-based material.

4. The RFID of claim 1, wherein the primer is a non-adhesive having flame retardant and resistant properties.

5. The RFID of claim 2, wherein the RFID is a tag adhered to a returnable container.

6. The RFID of claim 2, wherein the RFID is adhered to aerospace and automotive parts.

7. The RFID of claim 2, wherein the RFID is adhered to medical products.

8. The RFID of claim 1, wherein the RFID is resistant to chemicals.

9. The RFID of claim 2, wherein the polymer is a halogen having fire resistant and retardant additives.

10. The RFID of claim 2, wherein the RFID when exposed to 10 seconds of a flame in a vertical test would not burn after the flame was removed.

11. The RFID of claim 2, wherein the RFID is 20% flame retardant.

12. The RFID of claim 2, wherein the RFID is 30% flame retardant

13. The RFID of claim 1, wherein the primer layer is a non-adhesive.

14. The RFID of claim 2, wherein the polymer is polyethylene.

15. The RFID of claim 2, wherein the polymer is LDPE.

16. The RFID of claim 2, wherein the polymer is EVA.

17. A method of manufacturing an encapsulated RFID device comprising the steps of:
a. providing a primer, a polymer having flame retardant and resistant properties and an RFID device, the RFID device including a chip, an antenna, and a substrate, where the substrate includes a first surface and a second surface, the chip and the antenna are included on the first surface and wherein the encapsulated RFID device is flexible and able to conform to curved surfaces;
b. disposing a first layer of primer on the first surface of the RFID device;
c. disposing a second layer of primer on the second surface of the RFID device;
d. disposing a first layer of fire retardant or resistant polymer on the first layer of primer and disposing a second layer of fire retardant or resistant polymer on the second layer of primer encapsulating the RFID device

18. The method of claim 17, wherein the flame retardant and resistant properties are the result of additives selected from the group containing chlorine containing compounds, bromine containing compounds, halogen containing phosphoric esters.

19. The method of claim 17, wherein the polymer is halogen free and is copolymerized with a plastic material.
